(19) United States
(12) Patent Application Publication
(10) Pub. No.: US 2014/0172805 A1
(43) Pub. Date: Jun. 19, 2014

(54) CONTACT MANAGEMENT

(71) Applicant: MICROSOFT CORPORATION, Redmond, WA (US)

(72) Inventors: Derek Y. Leung, Seattle, WA (US); Michael A. Affronti, Seattle, WA (US); Ginger E. Tien, Bellevue, WA (US); Rikinkumar A. Shah, Sammamish, WA (US)

(73) Assignee: MICROSOFT CORPORATION, Redmond, WA (US)

(21) Appl. No.: 13/719,345

(22) Filed: Dec. 19, 2012

(51) Int. Cl. G06F 17/30

(52) U.S. Cl. CPC G06F 17/30303
USPC 707/692

(57) ABSTRACT

The description relates to contact management. One example can be manifest as a system that can include a display and a processor. The processor can be configured to process instructions to create a graphical user interface on the display. The graphical user interface can include an aggregate view of contact information relating to an entity. The graphical user interface can be configured to indicate a source of individual instances of the contact information. The aggregate view can be configured to distinguish first individual instances of the contact information that are editable from second individual instances of the contact information that are read-only.

### BACKGROUND

Contact information can be stored and accessed from multiple places, including different devices and different applications. Across all these devices and applications, there may be duplicate contact entries that represent the same person in real life. Keeping these duplicate entries synchronized and up to date is a challenge. Today, to add or update contact information, a user must go to each individual contact entry and make the update, and then do this N more times for each duplicate contact entry. This process is laborious, time consuming, and repetitive.

### SUMMARY

The described implementations relate to contact management. One example can entail generating an aggregate view of contact information relating to an entity, such as a person. The aggregate view can indicate a source of individual instances of the contact information. The aggregate view can also distinguish first individual instances of the contact information that are editable from second individual instances of the contact information that are read-only.

Another example can be manifest as a system that can include a display and a processor. The processor can be configured to process instructions to create a graphical user interface on the display. The graphical user interface can include an aggregate view of contact information relating to an entity. The graphical user interface can be configured to indicate a source of individual instances of the contact information. The aggregate view can be configured to distinguish first individual instances of the contact information that are editable from second individual instances of the contact information that are read-only.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1-8 illustrate examples of GUIs that can be generated using the present contact management concepts in accordance with some implementations.

FIG. 9 illustrates a system which can implement contact management concepts in accordance with some implementations.

FIG. 10 is a flowchart of a contact management method that can be accomplished in accordance with some implementations of the present concepts.

### DETAILED DESCRIPTION

### Overview

This patent relates to contact management. The present concepts can allow a user to view an aggregate view of contacts relating to a particular entity, such as a person or organization. The aggregate view can indicate (e.g., attribute) a source of individual portions of the aggregated contact information. Contact information from some sources can be edited, whereas other sources may not allow editing of their contact information (e.g., read-only). The individual contact information can be displayed in a manner which conveys whether they are editable or read-only. The user can make changes to the editable contact information and the changes can be automatically reflected in other portions of the editable contact information on the user's behalf.

### First Scenario Example

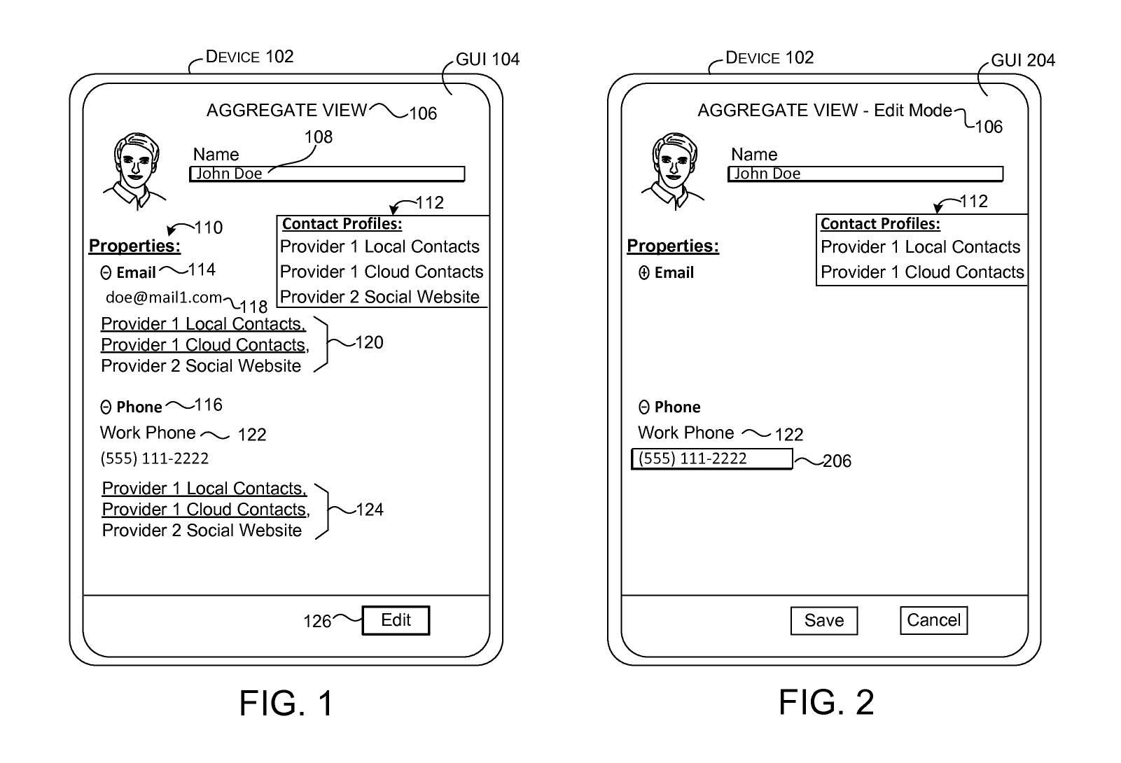

FIGS. 1-4 collectively show a device 102. The device is presenting a series of example graphical user interfaces (GUIs) that illustrate an aggregate view of contact information relating to a person.

FIG. 1 shows a GUI 104 of an aggregate view 106 of contact information relating to a person “John Doe” as indicated at 108. A user of device 102 can get to the aggregate view 106 in various ways, such as by selecting John Doe from a list of contacts (not shown). In this case, the contact information is organized into properties 110 and contact profiles 112. The properties 110 can include an email property section 114 and a phone property section 116. The properties can alternatively or additionally include other sections, such as address, title, etc. which are not shown here for sake of brevity and to avoid clutter on the drawing page. The contact profiles 112 shows the source of information in the properties section. In this case, the contact profiles 112 includes “Provider 1 Local Contacts”, “Provider 1 Cloud Contacts”, and “Provider 2 Social Website”.

In this example, the email property section 114 shows John Doe's email address as “doe@mailtcom” as indicated at 118. The source of the email address is listed as “Provider 1 Local Contacts”, “Provider 1 Cloud Contacts”, and “Provider 2 Social Website” as indicated at 120. Thus, the email address is attributed to each of these sources. Stated another way, in this case each of the contact profiles includes the same email address (e.g., doe@mailtcom). Note that this source information is presented in a distinguishing way to provide further information to the user. This aspect is described further below relative to the phone property section 116.

Under the phone property section 116, this example shows a work phone number as “(555) 111-2222” as indicated at 122. Further, the source of the work phone number is listed as “Provider 1 Local Contacts”, “Provider 1 Cloud Contacts”, and “Provider 2 Social Website” as indicated at 124. Thus, there are three instances of this individual property (e.g., the work phone number) from three different sources. Some instances can be editable, while others may be read-only.

This implementation provides a distinguishing indication to the user whether the source information is editable or read-only. In this case, the “Provider 1 Local Contacts” and “Provider 1 Cloud Contacts” are underlined at 124 to indicate that the information can be edited at the source (e.g., the “Provider 1 Local Contacts” and “Provider 1 Cloud Contacts”). In contrast, the “Provider 2 Social Website” is shown without underlining as an indication that the information cannot be changed at the source. Of course, this is only one of the contemplated ways to distinguish between editable and read-only source information. Alternatively or additionally, the listing of the sources in the contact profiles could distinguish the sources as providing editable data or read-only data utilizing the same type of underlined versus non-underlined distinction provided in the property section listings. The value of this editable/read-only aspect is explained in more detail below.

For purposes of explanation, assume that the user wants to edit the work phone number 122. Toward this end the user selects “edit” at 126 (shown in bold to indicate selection). Also, assume that the user has minimized the email property section 114 (to provide more room on the drawing page for explanation in FIGS. 2-4).

FIG. 2 shows a subsequent GUI 204 that is generated responsive to the user ‘edit’ selection relative to FIG. 1. The GUI now relates to the aggregate view—edit mode as indicated at 106. In this case, the work phone number 122 is shown in a box 206 to indicate that the phone number can be edited by the user. Note also, that in this implementation, in the Contact Profiles 112, only the editable contact profiles are shown. For example, the “Provider 1 Local Contacts” and “Provider 1 Cloud Contacts” are shown whereas the read-only “Provider 2 Social Website” is not shown (compare to FIG. 1). Of course other techniques can be used to distinguish editable content from non-editable content.

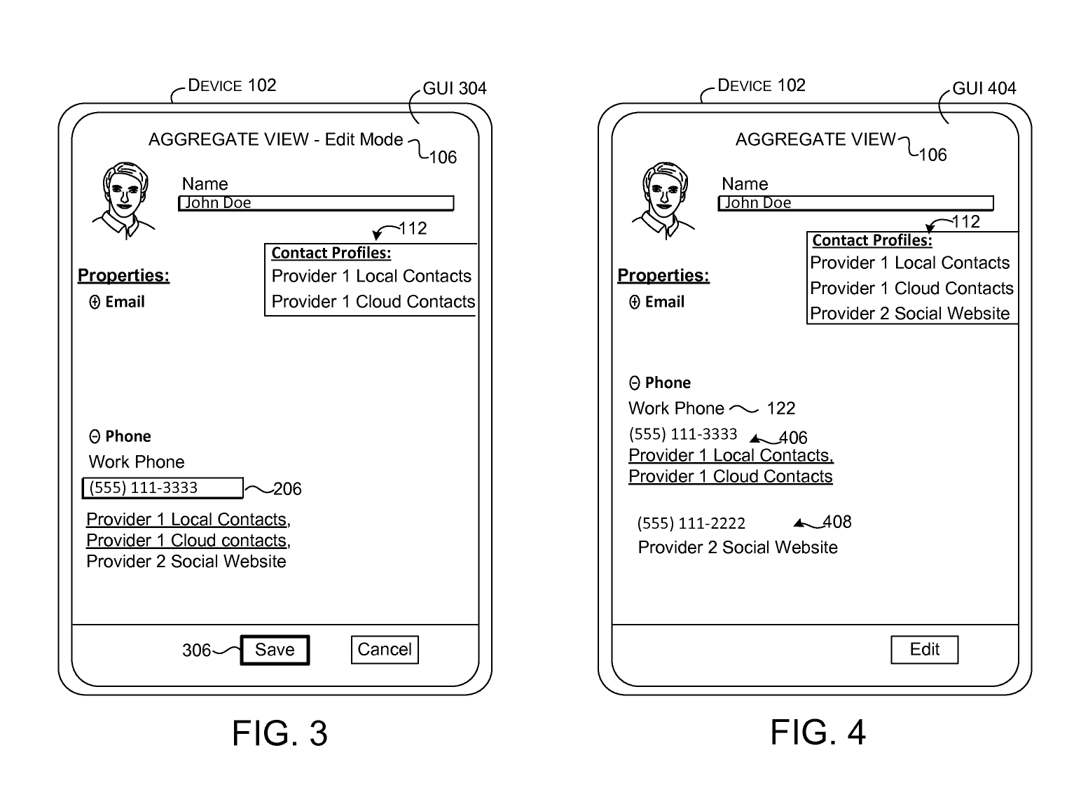

FIG. 3 shows a subsequent GUI 304 in the edit mode where the user has changed the work phone number in box 206 from “(555) 111-2222” to “(555) 111-3333”. Further assume that the user is satisfied with the change and selects “save” at 306.

FIG. 4 shows a GUI 404 generated responsive to the user action of FIG. 3. GUI 404 returns to the aggregate view of FIG. 1 from the aggregate view—edit mode of FIGS. 2-3. In GUI 404, the work phone number is now “(555) 111-3333” at the “Provider 1 Local Contacts” and “Provider 1 Cloud Contacts”) as indicated at 406. The work phone number at the “Provider 2 Social Website” is read-only and as such, remains “(555) 111-2222” as indicated at 408. To aid in the user's ability to understand the reason for the difference, the editable sources (e.g., the “Provider 1 Local Contacts” and “Provider 1 Cloud Contacts”) are shown underlined while the read-only “Provider 2 Social Website” is shown without underline. Thus, the user is provided with information about which sources were updated and why (or why not).

To summarize, the implementations described relative to FIGS. 1-4 can provide an aggregated view of information relating to a particular contact. The aggregated view can attribute individual portions of the information to individual sources. Further, the aggregated view can indicate which portions of the information are editable and which are read-only.

### Second Scenario Example

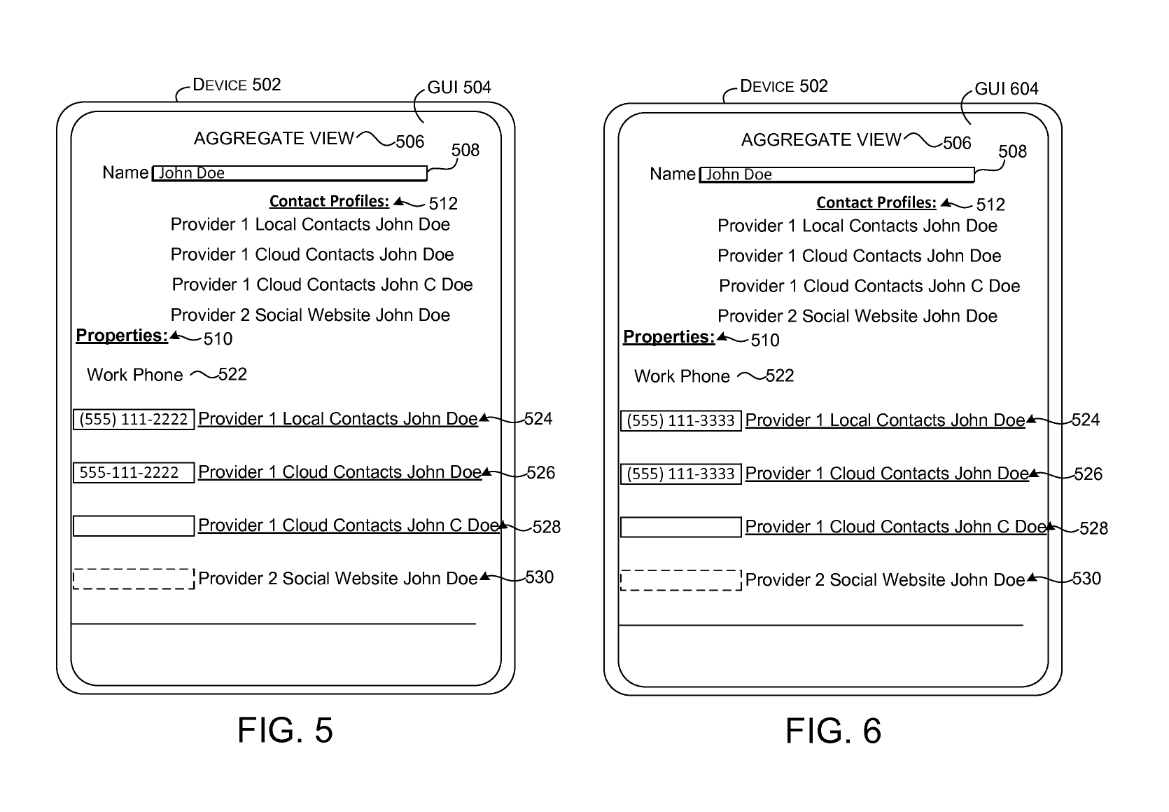

FIGS. 5-8 collectively show another device 502. For the sake of brevity as much as possible has been carried over from the previous example. Toward that end the leftmost numerals are changed from “1” to “5” to refer to similar elements. In this case, GUI 504 shows aggregated view 506 that includes four contact profiles for John Doe. In this scenario, the contact profiles 512 includes “Provider 1 Local Contacts John Doe”, “Provider 1 Cloud Contacts John Doe”, “Provider 1 Cloud Contacts John C. Doe”, and “Provider 2 Social Website John Doe”. Thus, even though the contact “John C Doe” is not literally identical in name to the others, this implementation can determine that all four relate to the same person and present all four on the aggregated view 506. Also note that for ease of explanation, the only illustrated property 510 is the work phone property 522.

In this case, under the work phone property 522, the “Provider 1 Local Contacts John Doe” shows a phone number entry of “(555) 111-2222” at line 524. Similarly, “Provider 1 Cloud Contacts John Doe” shows a phone number entry of “555-111-2222” at line 526. “Provider 1 Cloud Contacts John C. Doe” is associated with an empty box at line 528 to indicate no work phone number for this client at this source. Similarly, “Provider 2 Social Website John Doe” is shown with an empty box at line 530. Further, note that the empty box at line 530 is shown in dashed lines to indicate that the content cannot be changed (e.g., is read-only). In contrast, the boxes at lines 524, 526 and 528 are drawn with solid lines to indicate that the content in the box is editable. Thus, each line shows a value for the work phone number property, whether the value is editable, and an attribution to a source of the value.

Assume that the user wants to edit the work phone number in the box at line 524 from “2222” to “3333” (e.g., change from “(555) 111-2222” to “(555) 111-3333”). As such, the user can select the box at line 524 and make the change. FIGS. 6-8 represent three different implementations for handling the user's change.

FIG. 6 is a GUI 604 generated responsive to the user action described above relative to FIG. 5. In this case, note that the work phone number was changed at line 524 as entered by the user. The work phone number was also changed at line 526 even though the phone numbers listed in FIG. 5 were not exactly identical (e.g., “(555) 111-2222” versus “555-111-2222”). In this case, the work phone number instances were normalized and these two phone numbers were recognized as equivalents despite the differences. Stated another way, the two work telephone numbers were determined to be equivalents even though they are not identical. As such, the two work telephone numbers can be thought of as individual instances of the property that are normalized equivalents.

In FIG. 6, since the two instances (e.g., “(555) 111-2222” versus “555-111-2222”) are determined to be equivalents, the work phone number has been updated in both lines 524 and 526. However, this implementation did not apply the user edited value to line 528 because the values were not determined equivalent when normalized. For purposes of clarification, assume in an alternative situation that the work phone number value of line 528 in FIG. 5 was “555-111-1111” rather than blank. The result would be the same in this implementation, since when normalized, “555-111-1111” would be treated as non-equivalent to “(555) 111-2222” and thus would not be updated to reflect the user change to line 524. Thus, the present implementation makes the user change to normalized equivalents, but not other values and in this implementation a ‘blank’ is treated as a value.

Also, recall that the content of line 530 is read-only and as such cannot be updated. Thus, the user action is reflected in lines 524 and 526, but lines 528 and 530 remain unchanged (e.g., blank). Line 528 remains blank because it was determined not to be equivalent to line 524 and line 530 remains blank because it is read-only. The user could change line 528 by selecting the box and adding a value. The user cannot change the content in line 530 as indicated by the dashed box rather than the solid box of lines 524-528. The user could potentially go to the source of the content to make a change that would be reflected in line 530, but the present discussion relates to actions that can be taken from the aggregate view. However, even at the source the user may or may not have permission to make changes to the data. For instance, the social website may only allow “John Doe” to change John Doe's information. In this example, the user is not John Doe and as such is not permitted to make such changes.

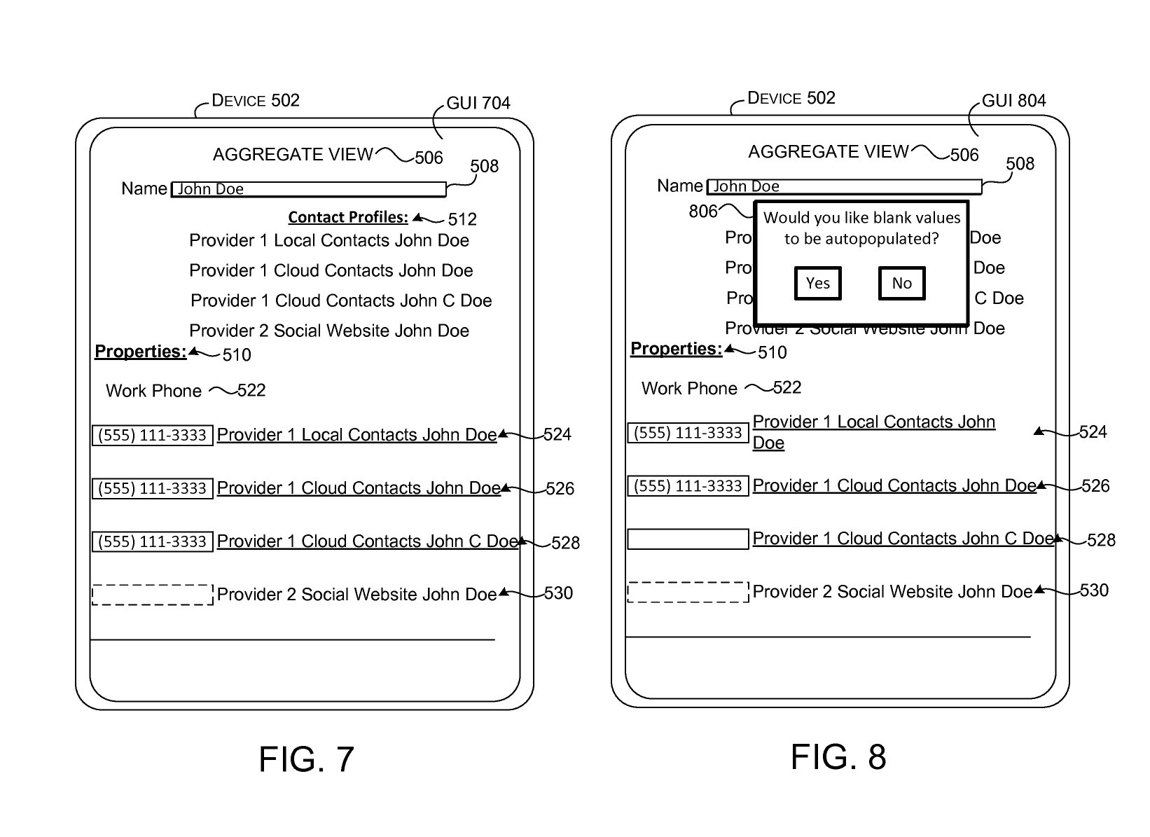

FIG. 7 shows an alternative implementation to that of FIG. 6. In this case, GUI 704 reflects the user change in normalized equivalents and also autopopulates the user change into blank editable values. As such, the user change of FIG. 5 is reflected in lines 524, 526, and 528, but not line 530 (which is read-only). This implementation can recognize equivalent values and autopopulate blank values within the property (except read-only) for the user.

FIG. 8 shows another GUI 804 that reflects still another implementation of the user changes described relative to FIG. 5. In this case, the changes are automatically performed relative to the normalized equivalent value of line 526. Further, the user is offered the option of autopopulating ‘blank’ work phone values. In this case, the option is presented as a dialog box 806 that allows the user to select or reject autopopulating of ‘blank’ values. If the user enters an affirmative response (e.g., selects “yes”) in the dialog box 806, then line 528 can be autopopulated as in FIG. 7. If the user selects “no” then line 528 remains blank as in FIG. 6.

The examples described above relative to FIGS. 5-8 can alternatively or additionally be applied to user additions and/or deletions. For example, if a user deletes a value in one property, some implementations can also delete equivalent editable values throughout the property. Similarly, if the user adds a value the added value can be autopopulated into other ‘blank’ values throughout the property.

In summary, the implementations of aggregate views described above can indicate a source of individual instances or portions of the contact information (e.g., attribution). In the illustrated examples of FIG. 5, the attribution is provided with each line 524-528. For example, in line 524 the individual instance of the contact information is the number “(555) 111-2222”. The source is “Provider 1 Local Contacts John Doe”. Further, the solid box of line 524 indicates an instance where the contact information is editable. In contrast, the dashed box of line 530 indicates that the content from this source is read-only. FIGS. 1-4 and 5-8 illustrate several configurations for implementing some of the present concepts. Of course, other configurations for implementing these concepts are also contemplated.

### System Example

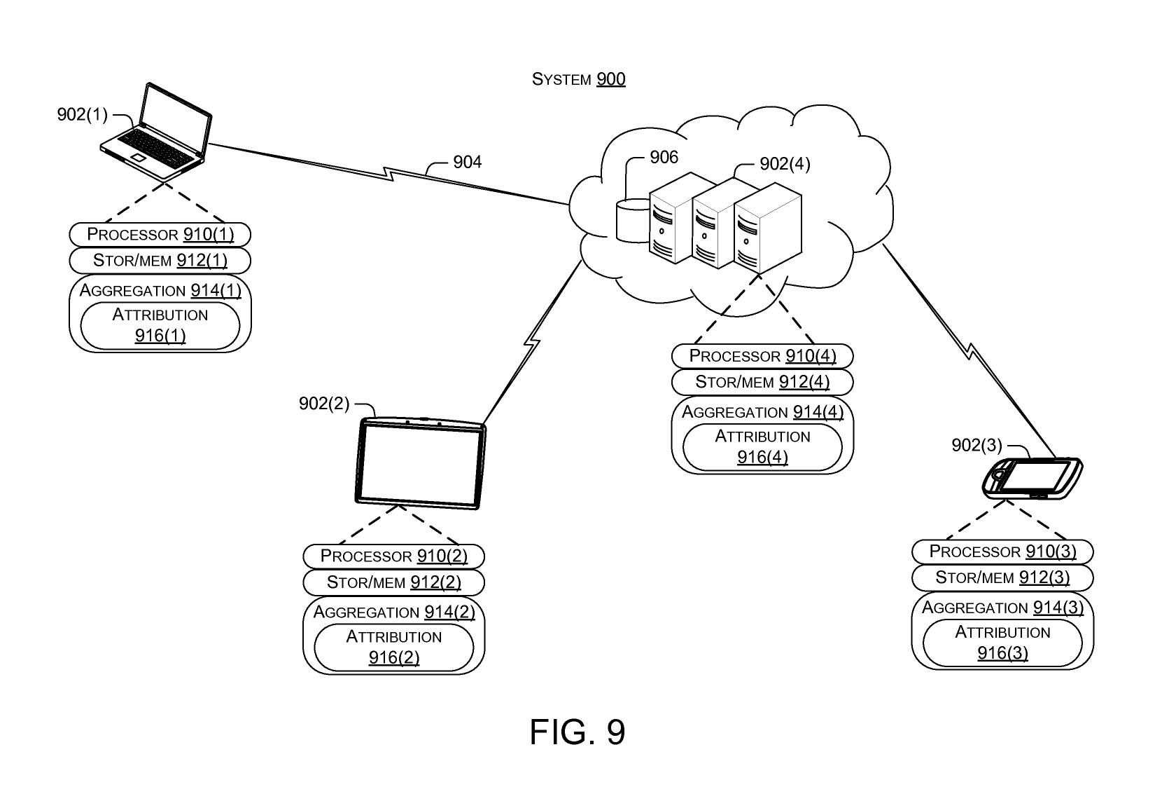

FIG. 9 illustrates a contact management system 900. In this example, the contact management system 900 includes several devices 902. In this case, the devices are manifest as a notebook type computer 902(1), a pad type computer 902(2) (similar to devices 102 and 502 described above relative to FIGS. 1 and 5, respectively), a smartphone type computer 902(3), and a set of cloud-based server type computers 902(4). (In this discussion, the use of a designator with the suffix, such as “(1)”, is intended to refer to a specific device instance. In contrast use of the designator without a suffix is intended to be generic). Of course not all device implementations can be illustrated and other device implementations should be apparent to the skilled artisan from the description above and below.

The devices 902 can communicate over one or more networks 904 (represented by ‘lightning bolts’). The devices can also communicate with a database 906. In some cases, the present concepts can be implemented by an individual device 902 acting in isolation. In other cases, a device can implement the present concepts by operating cooperatively with one or more other devices and/or the database 906. These variations are described in more detail below.

Devices 902 can include several elements which are defined below. For example, these devices can include a processor 910, storage/memory 912, and/or an aggregation component 914. The aggregation component can include an attribution module 916. The devices can alternatively or additionally include other elements, such as input/output devices (e.g., touch, voice, and gesture), buses, graphics cards, etc., which are not illustrated or discussed here for sake of brevity.

The term “device”, “computer” or “computing device” as used herein can mean any type of device that has some amount of processing capability and/or storage capability. Processing capability can be provided by one or more processors (such as processor 910) that can execute data in the form of computer-readable instructions to provide a functionality. Data, such as computer-readable instructions, can be stored on storage, such as storage/memory 912 that can be internal or external to the computer. The storage can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In the illustrated implementation devices 902 are configured with a general purpose processor 910 and storage/memory 912. In some configurations, a device can include a system on a chip (SOC) type design. In such a case, functionality provided by the device can be integrated on a single SOC or multiple coupled SOCs. One or more processors can be configured to coordinate with shared resources, such as memory, storage, etc., and/or one or more dedicated resources, such as hardware blocks configured to perform certain specific functionality. Thus, the term “processor” as used herein can also refer to central processing units (CPU), graphical processing units (CPUs), controllers, microcontrollers, processor cores, or other types of processing devices suitable for implementation both in conventional computing architectures as well as SOC designs.

In some configurations, the aggregation component 914 and/or the attribution module 916 can be installed as hardware, firmware, or software during manufacture of the device or by an intermediary that prepares the device for sale to the end user. In other instances, the end user may install the aggregation component 914 and/or the attribution module 916, such as in the form of a downloadable application.

Examples of devices can include traditional computing devices, such as personal computers, desktop computers, notebook computers, cell phones, smart phones, personal digital assistants, pad type computers, mobile computers, cameras, or any of a myriad of ever-evolving or yet to be developed types of computing devices. A mobile computer can be any type of computing device that is readily transported by a user and has a self-contained power source (e.g., battery). Aspects of system 900 can be manifest on a single device or distributed over multiple devices.

The aggregation component 914 and/or attribution module 916 can be freestanding elements or they can be elements of a contact management application. Examples of contact management applications can include Outlook® from Microsoft Corporation, Apple Contacts™ and/or Google Gmail™. The aggregation component 914 can function to link contacts that relate to the same person. The contacts can be thought of as duplicate contacts in that they relate to the same person. The duplicate contacts may be from different sources, and/or from the same source. The sources can be from multiple instances of the same contact management applications, different contact management applications, social media sites, websites, and/or corporate address books, among others. One such example is described relative to FIG. 5 above. The contacts can include editable and/or read-only information.

The aggregation component 914 can contribute to the aggregate view where linked contacts and information from the contact sources is deduplicated and aggregated, and presented to the user in one single user interface. Examples are described above relative to FIGS. 1-8.

The attribution module 916 can function to associate the source with the information. For instance, the attribution module can generate a portion of the GUI that indicates that ‘this specific item’ of contact information came from ‘this source’. Further, the attribution module can distinguish editable contact information from read-only contact information. For example, where the aggregation component 914 and the attribution module 916 are part of a contact management application that functions as a source, contact information from that source may be editable. In contrast, contact information from other contact management services and/or websites controlled by third parties may be read-only. Several examples of techniques for accomplishing this aspect are described above relative to FIGS. 1-8. The attribution module 916 can also normalize the values to determine which values are equivalent even if not literally identical. Several examples of these aspects are described above relative to FIGS. 1-8.

The aggregation component 914 and/or the attribution module 916 can facilitate several modes, such as edit mode, add mode, or delete mode associated with the aggregate view. In the edit mode, writable and read-only information can be shown in aggregate, and deduplicated. Writable information can be edited, whereas read-only data can only be viewed (not edited).

In some implementations, add mode (e.g., adding content mode) can limit user additions of a new piece of contact information for a given property to circumstances where one doesn't already exist. Stated another way, in these implementations, the user is not allowed to enter a value where another value already exists. The user could instead delete the current value and then add the new value or the user could select edit mode to change the value. This configuration can reduce and/or avoid multiple, potentially confusing values for a given property. This reduces the chance that outdated (e.g., incorrect) contact information is maintained in the contacts. It also can give a more consistent experience and expectation across all contacts when adding contact information. Stated another way, some implementations can encourage the user to change existing values rather than add new values and leave older potentially stale values.

In one configuration add mode allows a new piece of contact information to be propagated across duplicate contacts. Normalization can be employed to determine duplicate contacts. When a new value for a property is added, the value can be written to writable duplicate contacts that don't already have a value for that property.

The aggregation component 914 and/or the attribution module 916 can facilitate propagating information across writable contacts. For instance, when the user adds, edits, or deletes contact information, some configurations can be configured such that information is propagated to all writable duplicate contacts, when possible. The aggregation component 914 and/or the attribution module 916 can seek to make available the contact information for any contact, no matter the device or application used to view the contact information. Further, over time, these implementations can make duplicate contacts contain more consistent data amongst each other. Several variations of how this facet can be employed are described above relative to FIGS. 5-8.

The aggregation component 914 and/or the attribution module 916 can facilitate generation and/or presentation of the aggregate view of contact information. The attribution module 916 can indicate in the GUI where information is coming from/getting stored. This can be especially valuable to the user in instances where there are multiple values for a given property.

In some implementations, an individual device, such as for purposes of example, device 902(1), may operate in a free standing manner. The device can include the aggregation component 914(1) and the attribution module 916(1). For instance, the aggregation component 914(1) and the attribution module 916(1) could be installed on the device as part of a contacts management application. The contacts management application could operate upon and synchronize local contact information stored on the device. Alternatively or additionally, the contacts management system could synchronize contact information stored on other devices 902(2)-902(4) and/or database 906.

In some configurations, web-applications could exist on device 902(4) that include a contacts listing for the user. This cloud-based contacts listing can be thought of as ‘global’ in that it is not tied to a particular device. The global listing can be accessed from any device associated with the user. For instance, the web-application may automatically check the user's login and password from any device that attempts to access the web-application. From this information, the web-application can automatically present the global listing associated with the user (subject to security/privacy measures as desired). Alternatively or additionally, a local aggregation component 914(1) or a web-based version of aggregation component 914(4) can access the database 906 and/or other websites, such as social websites to obtain contact information on behalf of the user.

In some implementations, the device 902(1) may have a less robust instance of the contacts management application such that some or all of the functionality provided by the aggregation component 914(1) and the attribution module 916(1) is performed remotely, such as at cloud-based device 902(4) and communicated back to device 902(1) for presentation to the user. In some cases, aggregate view GUIs can be generated by the cloud-based device for presentation on device 902(1). For instance, aggregation component 914(1) and/or the attribution module 916(1) can serve to present GUIs generated remotely and to receive user input to the GUIs. The user input can then be communicated to the remote cloud-based device for processing.

### Method Example

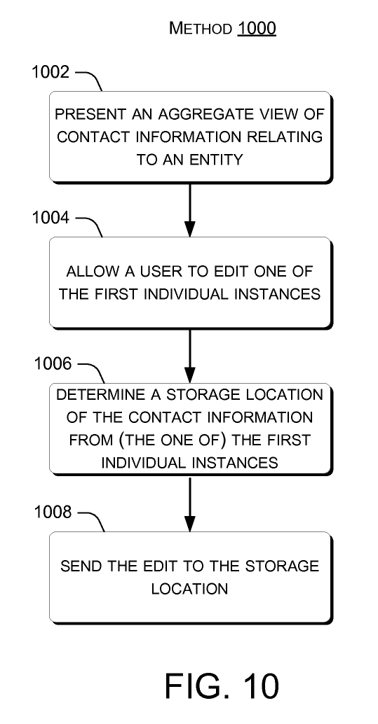

FIG. 10 shows a flowchart of a method 1000 for managing contact information. Method 1000 can be performed by the elements of system 900 or by other devices or systems.

The method can present an aggregate view of contact information relating to an entity, such as a person, at 1002. The aggregate view can indicate a source of individual instances of the contact information. The aggregate view can distinguish first individual instances of the contact information that are editable from second individual instances of the contact information that are read-only.

The method can allow the user to edit one of the first individual instances at 1004. For example, the user can edit a first value to a second value.

The method can determine a storage location of the contact information from (the one of) the first individual instances at 1006.

The method can send the edit (e.g., the second value) to the storage location at 1008.

While method 1000 relates to editing, other implementations can relate to adding or deleting contact information.

The methods described above can be performed by the systems and/or devices described above relative to FIGS. 1-9 and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on one or more computer-readable storage media as a set of instructions such that execution by a computing device causes the computing device to perform the method.

### CONCLUSION

Although techniques, methods, devices, systems, etc., pertaining to managing contact information are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. At least one computer-readable storage medium having instructions stored thereon that when executed by a computing device cause the computing device to perform acts, comprising:
generating an aggregate view of contact information relating to an entity,
wherein the aggregate view indicates sources of individual instances of the contact information, and
wherein the aggregate view distinguishes first individual instances of the contact information that are editable from second individual instances of the contact information that are read-only.

2. The computer-readable storage medium of claim 1, wherein the generating comprises presenting the aggregate view.

3. The computer-readable storage medium of claim 2, wherein the computing device comprises a mobile computing device.

4. The computer-readable storage medium of claim 1, wherein the computing device comprises one or more server computers.

5. The computer-readable storage medium of claim 1, wherein the aggregate view includes multiple instances from multiple different sources and further comprising accessing the multiple different sources to obtain the multiple instances.

6. The computer-readable storage medium of claim 1, further comprising organizing the contact information by properties and normalizing values of the individual instances within an individual property.

7. The computer-readable storage medium of claim 6, further comprising allowing a user to edit a value of one of the individual instances and applying the edited value to equivalent normalized other individual instances within the individual property.

8. The computer-readable storage medium of claim 7, further comprising autopopulating the edited value to further individual instances within the individual property that are blank.

9. The computer-readable storage medium of claim 8, wherein the autopopulating is performed automatically.

10. The computer-readable storage medium of claim 8, further comprising querying the user whether to perform the autopopulating, and wherein the autopopulating is performed responsive to receiving an affirmative response from the user.

11. A method, comprising:
presenting an aggregate view of contact information relating to a person, wherein the aggregate view indicates a source of individual instances of the contact information, and wherein the aggregate view distinguishes first individual instances of the contact information that are editable from second individual instances of the contact information that are read-only;
allowing a user to edit one of the first individual instances from a first value to a second value;
determining a storage location of the contact information from the one of the first individual instances; and,
sending the second value to the storage location.

12. The method of claim 11, wherein the presenting comprises generating the aggregate view.

13. The method of claim 12, wherein the generating is performed by a device upon which the user enters the second value.

14. The method of claim 11, further comprising determining equivalent values to the first value.

15. The method of claim 14, further comprising applying the second value to other of the first individual instances that have individual equivalent values to the first value.

16. A system, comprising:
a display;
storage having instructions stored thereon;
a processor configured to process the instructions to create a graphical user interface (GUI) on the display; and,
the GUI comprising an aggregate view of contact information relating to an entity and the GUI is configured to indicate a source of individual instances of the contact information, wherein the aggregate view is configured to distinguish first individual instances of the contact information that are editable from second individual instances of the contact information that are read-only.

17. The system of claim 16, embodied on a single device.

18. The system of claim 16, wherein the instructions comprise an aggregation component and an attribution module.

19. The system of claim 16, wherein the instructions comprise a contact management application that includes an aggregation component and an attribution module.

20. The system of claim 16, wherein the processor and storage are shared resources or wherein the processor and storage are dedicated resources.
